(19) United States
(12) Patent Application Publication
(10) Pub. No.: US 2008/0223296 A1
(43) Pub. Date: Sep. 18, 2008

(54) Paint Booth For Plants For Painting Products

(75) Inventor: Giovanni Giardini, Romano di Lombardia (IT)

Correspondence Address: CONNOLLY BOVE LODGE & HUTZ LLP, 1875 EYE STREET, N.W., SUITE 1100, WASHINGTON, DC, 20036, US

(73) Assignee: Trasmetal S.p.A., Milano (IT)

(21) Appl. No.: 11/997,282

(22) PCT Filed: Jul. 3, 2006
(86) PCT No.: PCT/EP06/63816

§ 371 Date: Jan. 29, 2008

(30) Foreign Application Priority Data
Jul. 29, 2005 (IT) BG 2005 A 000040

(51) Int. Cl. B05C 9/08; B05C 5/00

(52) U.S. Cl. 118/620; 118/323

(57) ABSTRACT

A paint booth for plants for painting products comprising: a supporting structure (10); one or more sheets (11), which define at least one portion of internal space (12) of said booth; and means (13) for surface treatment of said products. At least one of said sheets is mobile and has an opening through which said treatment means face within said portion of internal space, said at least one mobile sheet and/or at least one of said treatment means being connected to movement means (15), which impart a reciprocating motion simultaneously on said at least one mobile sheet and on said at least one treatment means.

The present invention relates to a booth of an improved type for applying powder paint, in particular for automatic plants for painting products.

As is known, plants for painting products dedicated to use of powder paints are provided with one or more booths in which the product undergoes one or more series of treatments, for example one or more painting stages and/or one or more stages of baking/cross-linking with IR or UV lamps or with hot air.

In particular in the case of electrostatic powder painting, booths normally have a structure that comprises a frame or framework, which supports a plurality of walls positioned in such a way that their internal surface will define a space designed to house one or more dispensers of painting material. Painting is carried out by causing the products to be treated to pass in the internal space of the booth in such a way that they are exposed to dispensing of the powder by purposely provided dispensers. The dispenser is in turn moved, for example along a vertical axis, so as to increase its working capacity.

The structure of the booth, and in particular of the walls, is intended to perform two fundamental functions. A first function regards the need to have deposition surfaces on which the powder that does not adhere to the product can be deposited so as to prevent its diffusion in the surrounding environment. A second function regards the need to remove the unused powder from the walls on which it has deposited in order to recover and reuse said powder, and above all in order to prevent, in subsequent painting operations, the powder from detaching and depositing on the products contaminating their final colouring.

For this purpose, known in the state of the art are different solutions that enable cleaning of the surfaces and of the internal space of the booths, which, however, although enabling an adequate removal and recover of the powders, present some disadvantages.

In particular, a first solution consists simply in the manual intervention by operators who remove the powder deposits from the walls and from the internal space of the booth. An alternative, which also requires manual intervention, involves instead removal and replacement of the sheets that form the walls at each colour change. It is, however, evident that said solutions, albeit effective, have a negative impact on the times and costs of production and force the operator to work in an unhealthy environment.

In order to avoid manual intervention, other solutions contemplate the use of walls provided with mobile sheets, generally made of deformable material, such as, for example, plastic sheets, which, through purposely provided actuation systems, are moved with respect to the system for removal of the painting powder. Said solution enables elimination of any manual intervention on the part of operators and relatively effective removal of the powder, but presents in any case some drawbacks.

For example, a manual intervention is in any case necessary for cleaning the internal space of the booth and the devices present therein, for example, paint guns or, in general, dispensers. In order to avoid manual intervention, other solutions contemplate use of walls made of rigid plastic material, with the possibility of automatic cleaning via purposely provided motor-driven apparatuses. This system limits the possibility of vertical development of the booth and moreover presents the drawback of being very costly.

A primary task of the present invention is to provide a paint booth, and in particular a paint booth for automatic plants for painting products, which will enable the problems referred to above to be overcome.

In the framework of the above task, a purpose of the present invention is to provide a paint booth that will not require, or in any case will minimize, manual cleaning interventions. Another purpose of the present invention is to provide a paint booth that will enable effective removal of the residue of painting material that is deposited on the walls of the booth.

A further purpose of the present invention is to provide a paint booth in which the paint-dispenser devices will be adequately protected from deposits of painting material.

Yet a further purpose of the present invention is to provide a paint booth that will enable an adequate cleaning not only of the walls but also of the space inside the booth, minimizing the risks of contamination between different painting lots.

Another purpose of the present invention is to provide a paint booth in which devices of actuation and movement of the sheets and/or of the devices for treatment of the products to be painted are simplified.

Not the least important purpose of the present invention is to provide a paint booth, and in particular a paint booth for automatic plants for painting products, which presents high reliability, and is relatively simple to produce at competitive costs.

This task, as well as the above and other purposes that will appear more clearly hereinafter, are achieved by a paint booth for plants for painting products that comprises: a supporting structure; one or more sheets, which define at least one portion of internal space of said booth; and means for surface treatment of said products. The booth according to the invention is characterized in that at least one of said sheets is mobile and has an opening through which said treatment means face within said portion of internal space. In addition, in the booth according to the invention at least one mobile sheet and/or at least one of said treatment means is connected to movement means that impart a reciprocating and simultaneous motion both on said mobile sheet and on said at least one treatment means.

For the purposes of the present invention, by the term “reciprocating motion” it is meant that the sheet and said treatment means are moved first in one direction and then in the opposite direction, traversing a certain stretch of the side surfaces of the internal space of the booth; by the term “simultaneous motion” it is meant that the sheet and said treatment means are moved in such way that their mutual position is always the same, i.e., in such a way that said treatment means is always in a position substantial corresponding to said opening of the sheet from which it faces the internal space of the booth.

Further characteristics and advantages of the present invention will emerge more clearly from the description of preferred, but non-exclusive, embodiments of a paint booth according to the invention, illustrated in the attached plate of drawings, in which:

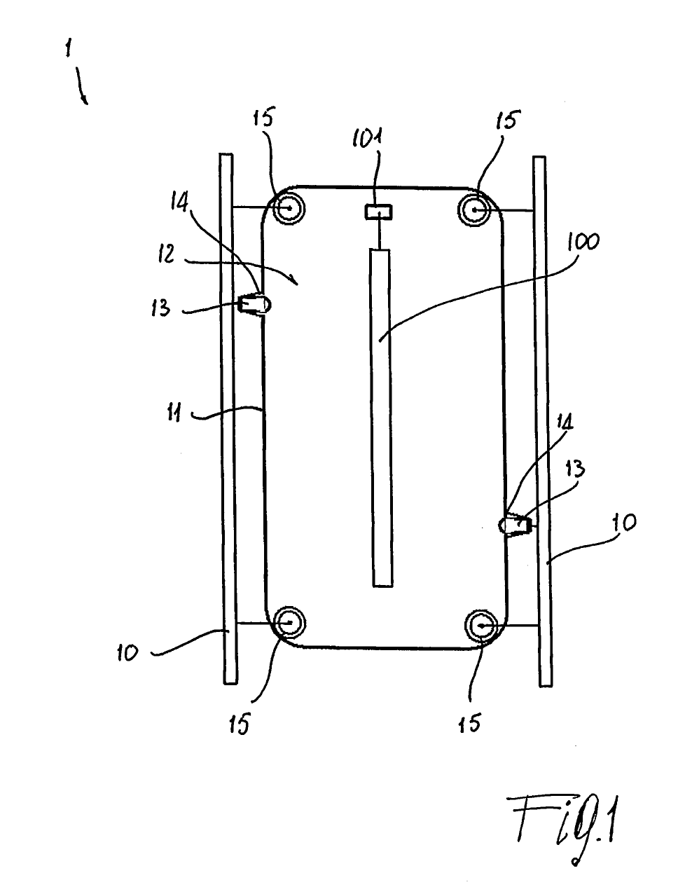

FIG. 1 is a schematic cross-sectional view of a first embodiment of a booth according to the invention;

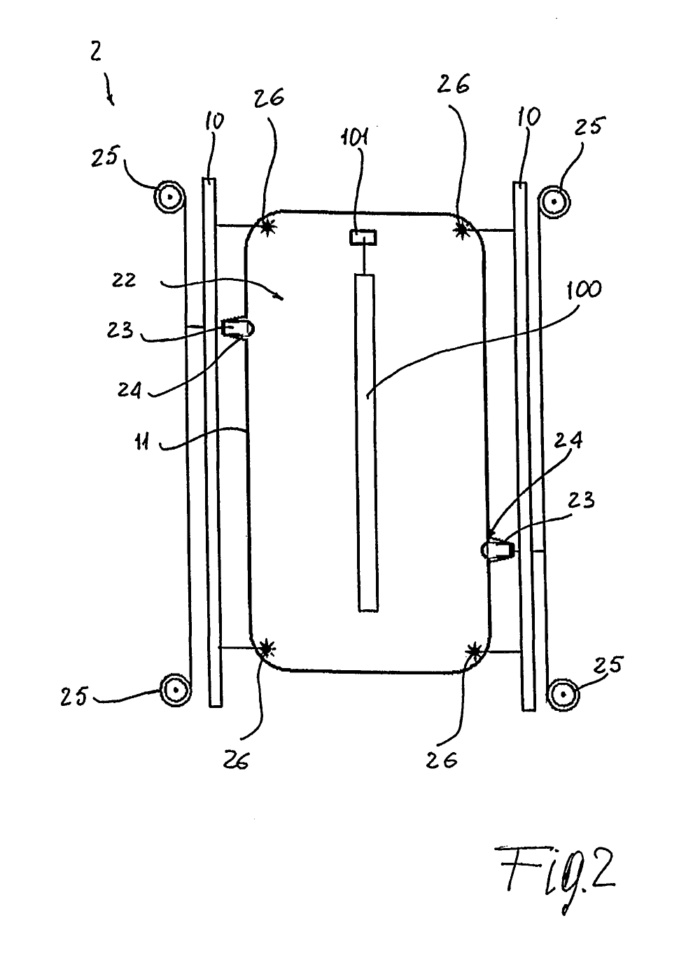

FIG. 2 is a schematic cross-sectional view of a second embodiment of a booth according to the invention;

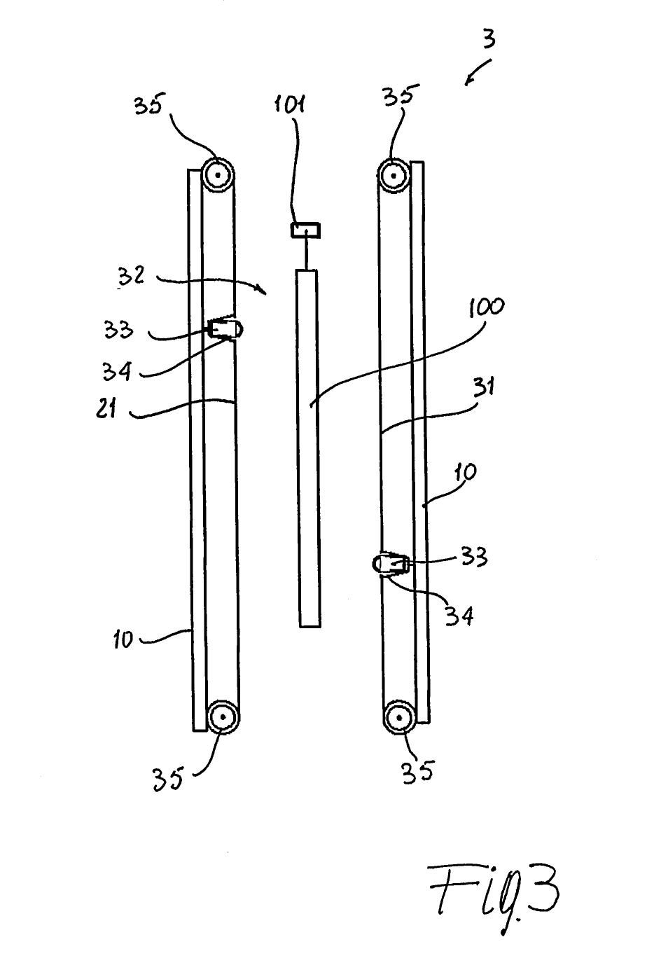

FIG. 3 is a schematic cross-sectional view of a third embodiment of a booth according to the invention;

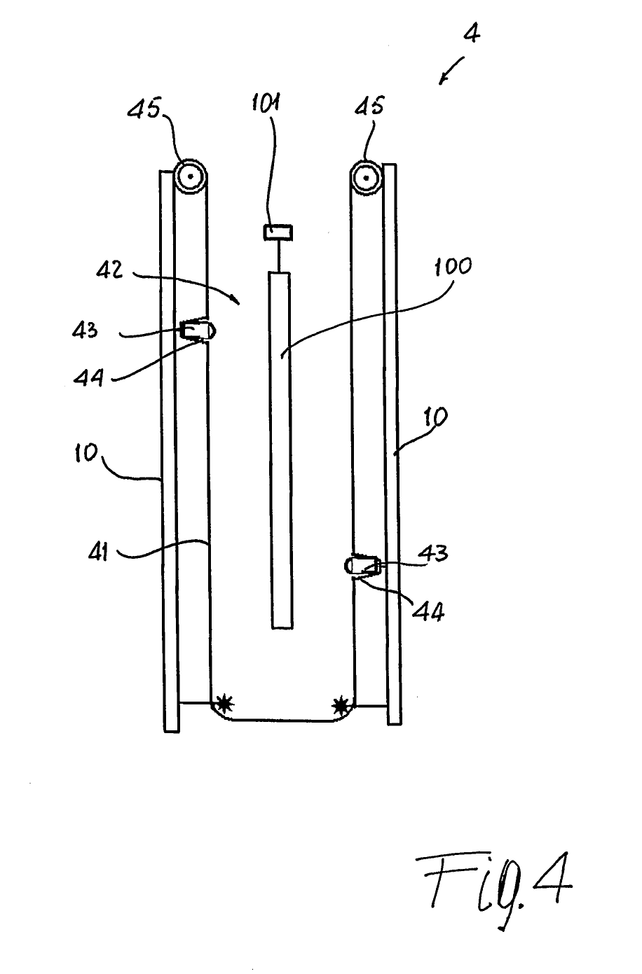

FIG. 4 is a schematic cross-sectional view of a fourth embodiment of a booth according to the invention;

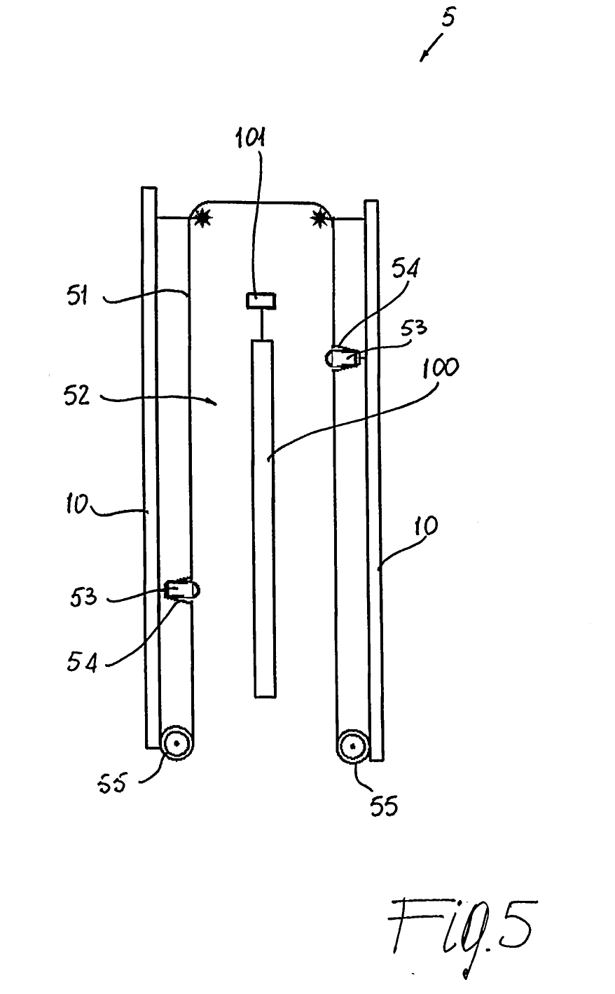

FIG. 5 is a schematic cross-sectional view of a fifth embodiment of a booth according to the invention;

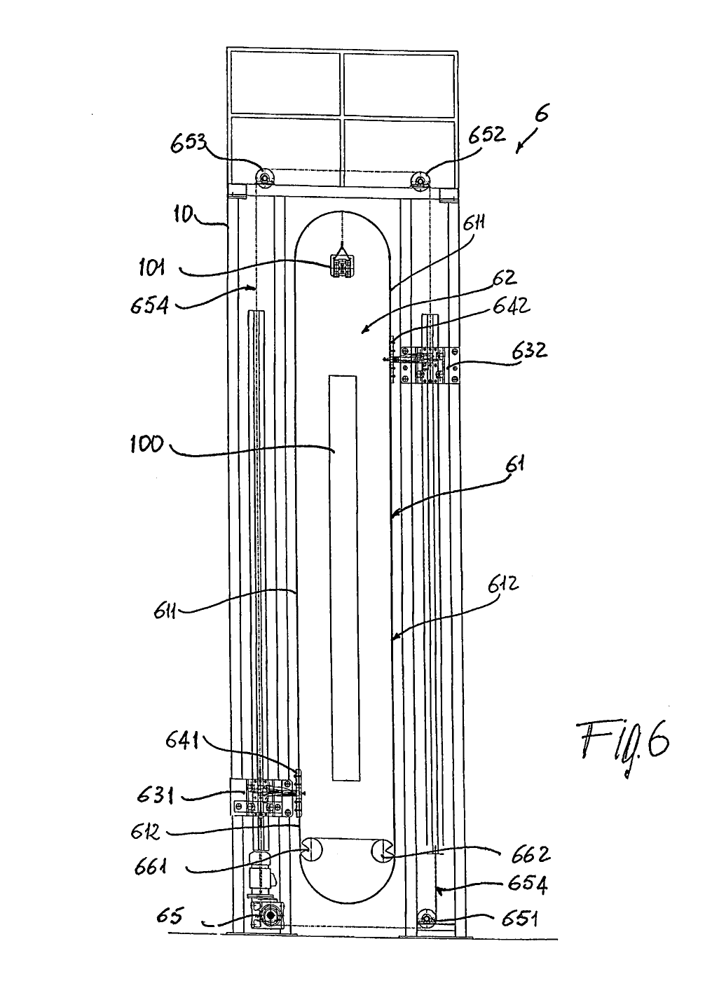

FIG. 6 is a cross-cross sectional view of a sixth embodiment of a booth according to the invention;

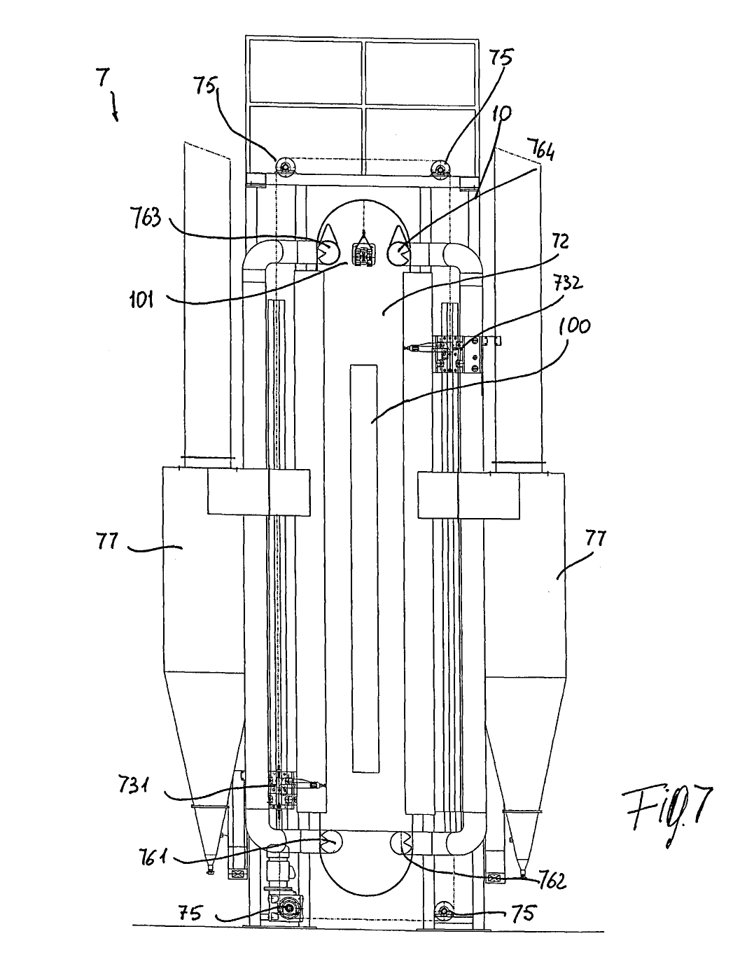

FIG. 7 is a cross-cross sectional view of a seventh embodiment of a booth according to the invention;

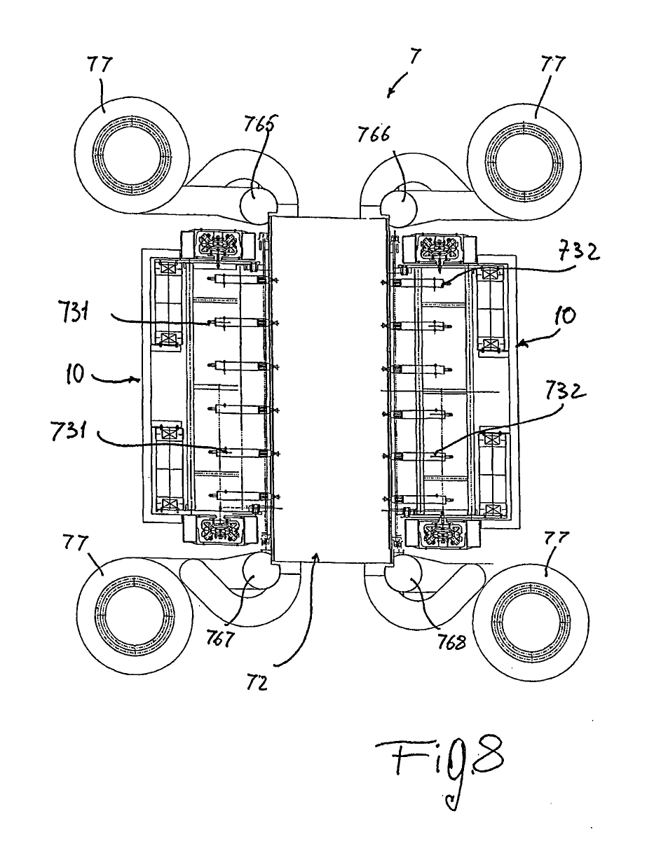

FIG. 8 is a top plan view of the booth of FIG. 7;

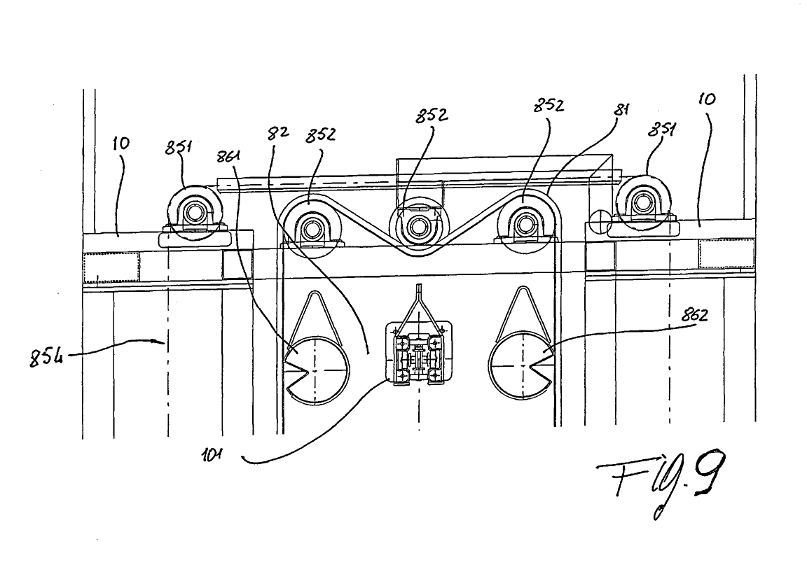

FIG. 9 is a cross-cross sectional view of a detail of an eighth embodiment of a booth according to the invention;

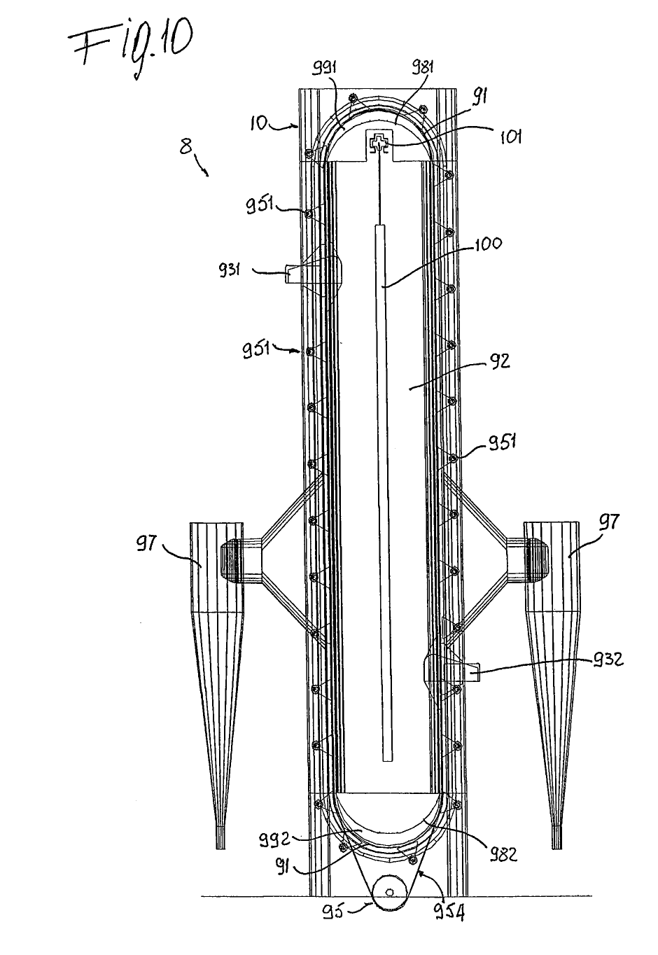

FIG. 10 is a cross-cross sectional view of a ninth embodiment of a booth according to the invention; and

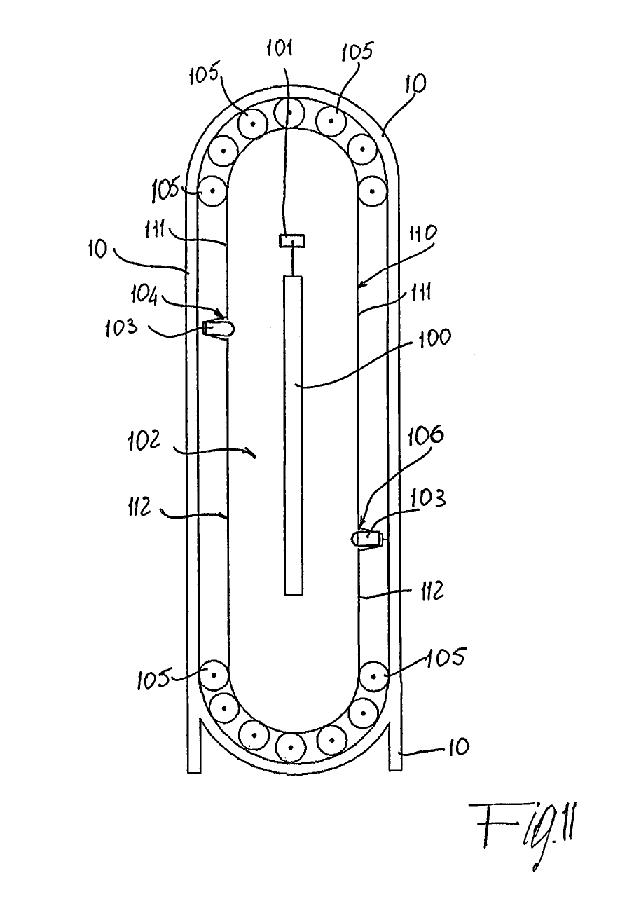

FIG. 11 is a schematic cross-sectional view of a tenth embodiment of a booth according to the invention.

The invention will be now described with reference to the annexed figures, in which the same reference numbers designate elements that are the same as one another, without wishing in any way to limit the sphere of application.

With reference to the figures referred to above, the paint booth according to the invention 1, 2, 3, 4, 5, 6, 7, 8 and 9 comprises a supporting structure constituted, for example, by a supporting framework. The booth further comprises one or more sheets, which define a portion of internal space 12, 22, 32, 42, 52, 62, 72, 82, 92 and 102 of the booth itself, and means 13, 23, 43, 53, 103, 631, 632, 731, 732, 931, 932 for surface treatment of said products.

The peculiarity of the booth according to the invention lies in the fact that at least one of said sheets 11, 21, 31, 41, 51, 61, 71, 81, 91 and 110 is mobile and has an opening 14, 24, 34, 44, 54, 641, 642, 104 and 106 through which said treatment means face within said portion of internal space. Said mobile sheet and/or at least one of the treatment means is connected to movement means 15, 25, 35, 45, 65 75 and 95, which impart a reciprocating and simultaneous motion both on the mobile sheet and on said treatment means. The mobile sheet can be generally constituted by any material designed to define a portion of internal space of the booth, resistant to the treatments to which the products are subjected within said booth and sufficiently flexible to enable its bending or rolling and unrolling during movement thereof via said movement means. The opening 14, 24, 34, 44, 54, 641, 642, 104 and 106 can also be made in at least one rigid or semirigid longitudinal cross member.

The sheet and the treatment means can be connected to the movement means independently of one another. Actuation of the movement means, and consequent movement of the sheet and of the treatment means is in this case synchronized in such a way that said treatment means is always in said opening of the sheet from which it faces the internal space of the booth.

According to a preferred embodiment, said at least one sheet and at least one treatment means are connected to one another so as to guarantee mutual transmission of motion. In this case, the movement means can be connected to said sheet or else can be connected to said treatment means in such a way that, in the former case, the movement of the sheet will be transmitted to the treatment means and, in the latter case, the movement of the treatment means will be transmitted to the sheet.

With reference to FIGS. 1 and 2, said at least one sheet 11 is closed in a longitudinal direction so as to define a tubular internal space 12, 22 having a substantially rectangular cross section. In practice, according to this embodiment, the sheet can be constituted by a flexible pipe of appropriate dimensions, which has one or more openings 14, 24 appropriately arranged, from which the treatment means 13, 23 face the internal space 12, 22 of the booth 1, 2. The openings 14 and 24 can also be arranged within at least one rigid or semirigid cross member throughout the longitudinal development of the sheet 11, which is thus found to be divided into two half-sheets, a top one and a bottom one, as will be described in greater detail hereinafter. In the embodiment of FIG. 1, the sheet 11 is appropriately connected to the supporting structure 10 through the movement means 15, which impart motion on the sheet itself. The sheet 11 is connected to the treatment means 13, which are in turn connected in a mobile way to the supporting structure 10. The products 100 enter the internal space 12 of the booth 1, for example hanging from an overhead conveying system 101, for example a chain or a rail, and are subjected to the action of the treatment means 13, which move with a reciprocating motion in a vertical direction on account of the motion transmitted by the movement means 15 through the sheet 11.

Alternatively (see FIG. 2), the movement means 25 can be connected to the treatment means 23, which are in turn mechanically connected to the sheet 11. The reciprocating motion in a vertical direction is then transmitted by the movement means 25 to the treatment means 23 and then to the sheet 11, which is connected in a mobile way to the supporting structure 10 through appropriate means 26.

Another possible embodiment, described in FIG. 3, envisages use of at least one first sheet 21 and one second sheet 31, which face one another so as to delimit at the sides a portion of internal space 32 of the paint booth 3. Said solution is particularly advantageous when the booth 3 does not require a top wall and a bottom wall or else when it is more convenient to use an independent bottom of the booth. In the embodiment of FIG. 3, the movement means 35 are connected to the sheets 21 and 31, which, once moved, draw along with them the treatment means 33 to which they are connected. Also embodiments are obviously possible in which the movement means are connected to the treatment means 33 (which hence draw along the sheets 21 and 31), or else are connected independently both to the treatment means 33 and to the sheets 21 and 31.

With reference to FIG. 4, a further embodiment of the booth according to the invention envisages that the sheet 41 will present a substantially U-shaped cross section so as to delimit at the sides and at the bottom a portion of internal space 42 of the booth 4. This solution can be used when the booth 4 requires the side and bottom walls but does not require a top wall. In the embodiment of FIG. 4, the movement means 45 are connected to the sheet 41. Obviously, also embodiments are possible in which the movement means are connected to the treatment means 43 (which hence draw along the sheet 41), or else are connected independently both to the treatment means 43 and to the sheet 41.

Likewise, in the case where the booth requires the side and top walls and does not require a bottom wall, a possible embodiment, described in FIG. 5, envisages that the sheet 51 will present a cross section substantially shaped like a U set upside down so as to delimit at the sides and at the top a portion of internal space 52 of the booth 5. The movement of the sheet 51 and of the treatment means 53, and the various forms of connection between the sheet 51, the treatment means 53, and the movement means 55 can occur in a way similar to what has already been described previously.

The treatment means 13, 23, 43, 53, 103, 631, 632, 731, 732, 931 and 932 can be of various types, according to the type of product 100 to be treated and to the type of treatment which it is to undergo. For example, the treatment means can be formed by spray guns or else by powder-paint guns, or else by powder-paint blades, or in general by powder-paint ejection means, or else again by UV lamps or IR lamps. In the case where the treatment booth is constituted by an IR jellying oven or a UV cross-linking oven, the sheet may be constituted by a metal strip with reflecting surface (for example, chrome-plated or aluminium-plated) and also coated or shaped in such a way that it will present reliefs (for example, having a conical or pyramidal shape with a square or polygonal base), designed to maximize the refraction of the UV or IR radiation in all directions so as to enable it to reach every recess of the object to be treated thus enabling optimal jellying or cross-linking of its entire surface.

Except in the cases where the paint booth according to the invention is designed for use as UV or IR oven, it can moreover comprise means for cleaning the internal surface of said sheet 11, 21, 31, 41, 51, 61, 71, 81, 91, 110 and said internal space of the booth itself. For example, said cleaning means can be formed by one or more suction manifolds positioned longitudinally in the internal space of the booth. The suction manifold has preferably at least one slit, which extends in a longitudinal direction, an edge of said slit being substantially in contact with the internal surface of the sheet. Preferably, the suction manifold is positioned in at least one of the top or bottom ends of the internal space 12, 22, 32, 42, 52, 62, 72, 82, 92 and 102 of the booth.

An example of an embodiment of the booth according to the invention that envisages use of suction manifolds is illustrated in FIG. 6. According to this embodiment, the paint booth 6 comprises a supporting framework 10, on which a sheet 61 and a set of treatment means formed by the guns 631 and 632 are positioned in a mobile way. In this case, the sheet 61 is provided with openings 641 and 642 that develop longitudinally throughout the length of the sheet itself, which is thus divided into two half-sheets 611 and 612, a top one and a bottom one, respectively. The two half-sheets 611 and 612 are connected to the load-bearing structure 10 by appropriate connection means (not illustrated in the figure) and define an internal space 62 of the booth 6, the cross section of which has two substantially rectilinear and parallel side walls, radiused at the top and at the bottom by two arcs of circle. The treatment means 631 and 632 are connected to the structure 10 so as to be able to slide vertically with reciprocating motion and are connected to the movement means, formed for example by a motor 65, through motion-transmission means, for example a drive chain or belt 654, and corresponding return means 651, 652 and 653. The treatment means 631 and 632 face the internal space 62 through the openings 641 and 642 and are mechanically constrained to the half-sheets 611 and 612 so as to draw them along during their motion.

The products to be treated 100 enter the internal space 62, for example hanging from an overhead conveyor 101, and undergo throughout their length the specific treatment for which the treatment means 631 and 632 are provided, for example a powder-paint treatment. This is made possible by the fact that the treatment means 631 and 632 move in a vertical direction and with a reciprocating motion during passage of the products 100 within the booth 6. The treatment means 631 and 632 are positioned in a substantially symmetrical way with respect to the transverse axis of the internal space of the booth, and their travel is adjusted in such a way that the entire surface of the product 100 will be treated.

In practice, as may be seen from FIG. 6, when the gun 631 is at the bottom dead centre, its position is lower than the bottom surface of the product 100. Simultaneously, the gun 632 is at the top dead centre and is higher than the top surface of the product 100. From this point on, the gun 631 moves upwards and the gun 632 moves downwards with a travel that exceeds the length of the product 100. During this movement, the sheet 61, drawn along by the treatment means 631 and 632, in practice slides along the edge of a longitudinal slit provided in two suction manifolds 661 and 662.

Said manifolds are arranged longitudinally in the internal space 62 of the booth 6, for example, at the bottom end of said internal space 62. In this way, the excess powder ejected by the guns is collected by the suction manifolds 661 and 662 and sent, for example, into purposely provided recovery cyclones (not illustrated in the figure). At the same time, since the guns 631 and 632 are positioned substantially on the outside of the space defined by the half-sheets 611 and 612, they are protected from any possible deposits of powder on them as well as on the corresponding accessory parts (cables, pipes, etc.).

A particular embodiment (not illustrated in the figures), envisages that the booth according to the invention will comprise first suction means set in a position corresponding to one or more openings of said mobile sheet 11, 21, 31, 41, 51, 61, 71, 81, 91 and 110, said first suction means moving simultaneously with said mobile sheet. In practice, in addition to the treatment means, the booth according to the invention can comprise suction means that face the internal space of the booth and move simultaneously to the treatment means and to the sheet so as to contribute to cleaning of the internal space of the booth and of the sheet itself. Said configuration can be applied in particular in the embodiment of booth provided in FIG. 3, which, since it is provided with two independent sheets, enables synchronized movement, at the front, of the powder dispensing means, alongside which or above which or underneath which there may be set the suction means.

The booth according to the invention can moreover comprise also second suction means positioned at the front and/or rear portion of said internal space. An embodiment of this type is illustrated in FIGS. 7 and 8. With reference to said figures, the paint booth 7 comprises a supporting framework 10, positioned in a mobile way on which are a sheet 71 and a set of treatment means constituted by the guns 731 and 732. The treatment means can be connected to the sheet 71 and to the movement means 75 and to the return means 751, 752, 753, as described for the booth of FIG. 6, and their movement occurs as described previously. The booth 7 further comprises a first suction manifold 761 and a second suction manifold 762, arranged longitudinally in the proximity of the bottom of the internal space 72 of the booth, and a third suction manifold 763 and a fourth suction manifold 764 arranged longitudinally in the proximity of the top of the internal space 72 of the booth. Said manifolds can be provided with a covering element 765, which prevents, or limits considerably, the accumulation of painting powder on the top portion of the manifold itself As described for the booth 6 of FIG. 6, the manifolds 761, 762, 763 and 764 contribute to cleaning of the sheet 71 and of the internal space 72 of the booth 7.

The booth 7 further comprises second suction means formed, for example, by the suction manifolds 765, 766, 767 and 768 positioned vertically in the front and rear portion of the internal space 72. The suction manifolds 765, 766, 767 and 768 have a slit, which extends in a vertical direction in the proximity of the internal surface of the mobile sheet 71 and contribute to cleaning of the sheet 71 and of the internal space 72 of the booth. Both the horizontal manifolds 761, 762, 763, 764 and the vertical manifolds 765, 766, 767, 768 are appropriately connected to the cyclones 77 in which recovery of the powder sucked in occurs.

With reference to FIG. 9, a possible further embodiment of a booth according to the invention will now be illustrated, with particular reference to the connection between the mobile sheet and the load-bearing structure. In this embodiment of the booth, only a detail of the top part of which is illustrated, the sheet 81 can be connected to the treatment means, not illustrated in the figure, so as to be driven thereby. Said treatment means are connected to movement means, not illustrated in the figure, for example through the drive chain or belt 854 and the corresponding return means 851. The movement of the treatment means and of the sheet 81 can occur in a way similar to what has been described previously with reference to FIG. 6. The sheet 81 is in this case supported by rollers 852 appropriately positioned and pivoted on the supporting framework 10 so as to enable movement of the sheet itself and guarantee its support and adequate tensioning. A similar system of rollers can be positioned in the bottom part of the booth so as to guarantee adequate positioning and tensioning of the sheet 81.

Alternatively, with reference to FIG. 10, the sheet 91 can be connected to a series of rotating elements (such as rollers, wheels, bearings, and the like) 951 set at a distance from one another and able to move along a sliding rail or guide present on the supporting structure 10. The movement means, for example, a motor 95, are in this case connected via a drive belt 954 directly to the sheet 91, or else to the treatment means 931 and 932, in turn connected to the sheet 91. Movement of the sheet 91 and of the treatment means 931 and 932 hence occurs with a reciprocating motion in a vertical direction as already described previously. Once again with reference to FIG. 10, the paint booth according to the invention can comprise one or more fixed elements that delimit the internal space 92. In the case of FIG. 10, a first fixed element 981 delimits at the top said internal space, whilst a second fixed element 982 delimits it at the bottom. The positioning and conformation of the top fixed element 981 enables, as in the case of FIG. 10, the overhead conveyor 101 to be protected and remain clean, whilst the bottom fixed element 982 enables a more easy collection of the treatment residue for example of the painting powder. Preferably, the fixed elements 981 and 982 are positioned inside and in substantial contiguity with the mobile sheet 91 so as to define a longitudinal cavity, respectively a top cavity 991 and a bottom cavity 992. The substantial contiguity between the sheet 91 and the fixed elements 981 and 982 facilitates detachment of the treatment residue from the surface of the sheet 91; at the same time, if the longitudinal cavities 991 and 992 are connected to suction or blowing means, not illustrated in the figure, it is possible to remove and collect the treatment residue and thus contribute to cleaning of the sheet 91 and of the space inside 92 the booth 8.

A particularly preferred embodiment envisages that the mobile sheet is substantially self-bearing. This can be made using a flexible material provided with a sufficient rigidity to obtain the mobile sheet. With reference to FIG. 11, this embodiment envisages that the booth 9 will be equipped with a supporting structure 10 on which there can be positioned purposely provided means for interface with the mobile sheet 110, made up, for example, of a plurality of rollers 105 pivoted on the structure 10. The same structure 10 moreover supports a set of treatment means formed by guns 103. In this case, the sheet 110 is provided with openings 104, which develop longitudinally throughout the length of the sheet itself, which is thus divided in two half-sheets 111 and 112, a top one and a bottom one, respectively. The two half-sheets 111 and 112 are made of a material that is sufficiently rigid as to guarantee the dimensional stability of the sheet itself, and at the same time sufficiently flexible to be able to bend at the top and bottom ends of the internal space of the booth 9. The cylinders 105 are positioned so as to form the arc of a circle at the top and bottom ends of the internal space of the booth 9 and define a sort of housing seat for the sheet 110. Inserted within the seat defined by the rollers 105 are the half-sheets 111 and 112, which are sized so as to adapt to said seat and exert on the rollers 105 an elastic thrust that guarantees maintenance of their correct positioning. Possibly other rollers, or similar elements, can also be positioned along the internal side walls of the structure 10 so as to compensate for the lateral elastic thrusts outwards that would tend to deform the sheets. Conversely, if necessary, containment elements may be envisaged for compensating for the lateral elastic thrusts inwards, such as rails or claws to be positioned at the side edges of the sheets, or again longitudinal scrapers or brushes, which function both as cleaning elements and as containment elements. In practice, the two half-sheets, appropriately connected to the treatment means 103 at the openings 104, are provided so as to form a sort of flattened elastic pipe that is inserted within space defined by the rollers 105. The treatment means 103 are mechanically constrained to the half-sheets 111 and 112 so as to draw them along during the motion generated by movement means, not illustrated in the figure, to which they are connected. The half-sheets 111 and 112 move, with a reciprocating motion, fixedly with the treatment means 103, and their movement is favoured by the smoothness guaranteed by the rollers 105. The treatment of the products 100 hence occurs as described previously.

The use of sheets made of materials that present a particularly high level of performance from the standpoint of elasticity may also enable self-bearing booths to be provided, which do not need any containment either for the thrusts outwards (e.g., rollers) or for the thrusts inwards (claws, rails, scrapers or brushes).

It may be seen how the paint booth according to the invention will enable the pre-set task and purposes to be fully achieved. Appropriate positioning of the treatment means at the openings of the mobile sheet enables said treatment means to be protected and their dirtying by the painting material to be prevented or minimized. At the same time, the movement of the sheet, combined with the presence and the appropriate positioning of cleaning means (suction means, scraper/brush or combinations of the two) enables effective removal of the residue of painting material from the sheets themselves and from the internal space of the booth.

Another important result that is achieved by the booth according to the present invention, is the optimization of the movement means of the mobile sheet and of the treatment means. Unlike booths of a known type that require at least two movement devices for moving separately the sheet and the treatment means, the booth according to the invention enables a mechanical connection with consequent transmission of motion between the mobile sheet and the treatment means. The result is that, as illustrated in some examples of embodiment of the booth according to the invention, it is sufficient to have a single moving device, which controls either the treatment means or the mobile sheet; in the former case, the mobile sheet will be driven in motion by the treatment means, whereas in the latter case the treatment means will be will be driven in motion by the mobile sheet. This enables reduction in the mechanical complexity of the booth and reduction in the costs of installation and maintenance of the booth itself and of the plant associated thereto.

Furthermore, according to a preferred embodiment, the mobile sheet can be provided so as to be substantially self-bearing, with consequent further constructional simplification and reduction in the installation costs.

The booth according to the present invention may be conveniently applied to plants for painting products. Plants for painting products, and in particular automatic painting plants that comprise one or more booths according to what has been described previously, constitute a further aspect of the present invention.

On the basis of the foregoing description, other characteristics, modifications or improvements are possible and evident to the average person skilled in the branch. Said characteristics, modifications and improvements are hence to be considered as forming part of the present invention. In practice, the materials used as well as the contingent dimensions and shapes, may be any whatsoever according to the requirements and the state of the art.

1. A paint booth for plants for painting products comprising: a supporting structure; one or more sheets, which define at least one portion of internal space of said booth; and means for surface treatment of said products, said paint booth being characterized in that at least one of said sheets is mobile and has an opening through which said treatment means face within said portion of internal space, said at least one mobile sheet and/or at least one of said treatment means being connected to movement means, which impart a reciprocating motion simultaneously on said at least one mobile sheet and on said at least one treatment means.

2. The paint booth according to claim 1, characterized in that said at least one sheet and at least one treatment means are connected to one another so as to guarantee mutual transmission of motion.

3. The paint booth according to claim 2, characterized in that said movement means are connected to said at least one sheet.

4. The paint booth according to claim 2, characterized in that said movement means are connected to said at least one treatment means.

5. The paint booth according to claim 1, characterized in that said at least one sheet is closed in a longitudinal direction, defining a tubular internal space having a substantially rectangular cross section.

6. The paint booth according to one or more of claim 1, characterized in that it comprises a first sheet and a second sheet facing one another so as to delimit laterally a portion of internal space of said booth.

7. The paint booth according to one or more of claim 1, characterized in that said at least one sheet has a substantially U-shaped cross section and delimits at the sides and at the bottom a portion of internal space of said booth.

8. The paint booth according to one or more of claim 1, characterized in that said at least one sheet has a cross section substantially shaped like a U set upside down and delimits at the sides and at the top a portion of internal space of said booth.

9. The paint booth according to one or more of claim 1, characterized in that said at least one sheet has a first opening and one second opening which extend longitudinally throughout the length of the sheet defining a first, top, half-sheet and a second, bottom, half-sheet.

10. The paint booth according to claim 1, characterized in that said treatment means are chosen between powder-paint guns and/or powder-paint blades and/or UV lamps and/or IR lamps.

11. The paint booth according to claim 1, characterized in that it comprises means for cleaning the internal surface of said sheet.

12. The paint booth according to claim 11, characterized in that said means for cleaning the internal surface of said sheet comprise a suction manifold positioned longitudinally in said internal space, said suction manifold having at least one slit, which extends in a longitudinal direction, an edge of said slit being substantially in contact with the internal surface of said sheet.

13. The paint booth according to claim 12, characterized in that said suction manifold is positioned at at least one of the top or bottom ends of said internal space.

14. The paint booth according to claim 1, characterized in that it comprises first suction means positioned at one or more openings of said mobile sheet, said first suction means moving simultaneously with said mobile sheet.

15. The paint booth according to claim 1, characterized in that it comprises second suction means positioned at the front and/or rear portion of said internal space.

16. The paint booth according to claim 15, characterized in that said second suction means comprise a suction manifold positioned vertically at the front and/or rear portion of said internal space, said suction manifold having at least one slit, which extends in a vertical direction in the proximity of the internal surface of said mobile sheet.

17. The paint booth according to claim 1, characterized in that said internal space is delimited at the top and/or at the bottom by a fixed element.

18. The paint booth according to claim 17, characterized in that said fixed element is positioned inside and in substantial contiguity with said mobile sheet so as to define a longitudinal cavity.

19. The paint booth according to claim 1, characterized in that said mobile sheet is self-bearing.

20. A painting plant comprising one or more paint booths according to claim 1.
